(19) United States
(12) Patent Application Publication
(10) Pub. No.: US 2012/0136920 A1
(43) Pub. Date: May 31, 2012

(54) ALERT AND MEDIA DELIVERY SYSTEM AND METHOD

(76) Inventors: Robert W. Rosentel, Nashua, NH (US); Arthur Eric Jones, Lawrenceville, NJ (US); Joseph E. Perkins, Niles, OH (US); Vincent C. Grosso, New York, NY (US)

(21) Appl. No.: 13/072,341

(22) Filed: Mar. 25, 2011

Related U.S. Application Data
(60) Provisional application No. 61/418,343, filed on Nov. 30, 2010.
(60) Provisional application No. 61/433,137, filed on Jan. 14, 2011.

(51) Int. Cl. G06F 15/16

(52) U.S. Cl. 709/203

(57) ABSTRACT

Alert and media systems and methods are disclosed. In some embodiments, a method comprises providing content to a site comprising the steps of managing, by a network operations center module, a plurality of content files comprising at least one alert file and at least one multimedia file, delivering the content file from the network operations center module to a communicatively connected network server module associated with the site based on one or more site-specific rules enforced by the network operations center module, and providing, by the network server module, the content file to a communicatively connected network interface module configured to receive the content file and convert the content into a format suitable for display on a communicatively connected display device.

### REFERENCE TO PRIORITY APPLICATIONS

This application claims priority to U.S. Provisional Patent Application No. 61/418,343, filed on Nov. 30, 2010, titled SYSTEM AND METHODS FOR AN ALERT AND MEDIA SYSTEM and U.S. Provisional Patent Application No. 61/433,137, filed on Jan. 14, 2011, titled SYSTEM AND METHODS FOR AN ALERT AND MEDIA SYSTEM which are both incorporated herein by reference.

### FIELD OF THE INVENTION

The present invention relates to systems and methods for delivering alerts and multimedia content to sites utilizing a network such as the Internet. Exemplary implementations of the systems and methods disclosed herein are directed to the delivery of multimedia content and alerts to educational facilities.

### BACKGROUND OF THE INVENTION

Media and content delivery systems have become a ubiquitous feature of modern society. Many homes, businesses and schools receive multimedia content from broadcast channels and cable and satellite providers. In addition to delivering multimedia content such as news programs, entertainment and other programming, current media systems are also capable of delivering alerts regarding emergency conditions. For example, the Emergency Alert System (EAS) is a national emergency system implemented by the Federal Emergency Management Administration in 1997 which superseded the older Emergency Broadcast System. The EAS covers various radio and television frequency bands such as AM, FM, VHF and UHF. In addition, cable, digital television, digital radio, satellite radio and satellite television broadcasters are required to participate in EAS.

All broadcast stations and multichannel video programming distributors are required to install EAS decoders and encoders that continuously monitor other nearby broadcast stations for EAS messages. When an emergency alert is received through the EAS, normal programming is altered or suspended by the broadcast station, an attention signal is sent and an audio message (in the case of radio) or text “crawl” (in the case of television) is broadcast. The message detail depends on the type of alert and can include specific instructions or additional information. Alerts may be related to weather, chemical spills or other industrial disasters, national emergencies or terrorism. EAS currently relies on affiliated broadcasters to delivery the alert content to the viewer (or listener in the case of radio broadcasts).

While current media and notification systems are effective at reaching the public who happen to be listening to the radio or watching television when the alert is received, these systems do not reach school classrooms and other closed environments in a timely manner (e.g., an environment not receiving standard broadcasts in a consistent and dedicated manner). In addition, these alert systems are not currently integrated with content delivery systems that use the Internet as the primary means of transmitting content. Further, existing systems are not capable of remotely activating devices such as projectors and interactive white boards that have become more common in today's school and corporate environments for purposes of broadcasting alerts. Moreover, existing media and alert systems are not capable of broadcasting customized alerts and messages that may be of importance to school and corporate environments. Therefore, a need exists in the art to address the shortcomings of current alert systems and to integrate these systems with multimedia delivery systems that rely on the Internet for content delivery.

### SUMMARY OF THE INVENTION

The above-described problems are addressed and a technical solution is achieved in the art by the alert network and media systems and methods described herein. According to one or more embodiments of the present invention, a method for providing content files to a site (e.g., an educational facility, school) is described which comprises the steps of managing, by a network operations center module, a plurality of content files comprising at least one alert file and at least one multimedia file; delivering the content file from the network operations center module to a communicatively connected network server module associated with the site based on one or more site-specific rules enforced by the network operations center module; and providing, by the network server module, the content file to a communicatively connected network interface module configured to receive the content file and convert the content into a format suitable for display on a communicatively connected display device. In some embodiments, the plurality of content files may be received from a plurality of communicatively connected sources (e.g., government and third party sources).

In some embodiments, the network interface module is configured to boot based on a boot image received from the network server module. The network interface module may also be configured to power on the communicatively connected display device in order to display content received from the network operations center module. The network interface module may also control a display source switch module for switching an input to the display device between the network interface module and one or more other display sources (e.g., a teacher's computer connected to the display device). In some embodiments, the network interface module may switch, by the display source switch module, from one of the other display sources to the network interface module when a time-sensitive alert is communicated to the network interface module.

An exemplary system according to embodiments of the present invention comprises a network operations center module, a network server module and a network interface module. According to an embodiment of the present invention, the network operations center module is configured to manage a plurality of content files comprising at least one alert file and at least one multimedia file. The network server module associated with a site may be configured to receive content (e.g., multimedia content, alerts, etc.) from the network operations center module based on one or more site-specific rules enforced by the network operations center module. Preferably, the network server module resides locally at the site. The network interface module may be configured to receive content files from the network server module and convert the content files into a format suitable for display on a communicatively connected display device. Preferably, the network interface module is located in a classroom in proximity to the display device.

An exemplary computer readable medium may comprise executable instructions, the instructions being executable by a processor to perform an exemplary method. The method may comprise providing content to a site comprising the steps of receiving from a network operations center module content files comprising at least one of an alert file and a multimedia file from a plurality of sources, including government and third party sources, delivering the content files from the network operations center module to a communicatively connected network server module residing locally at the site based on one or more site-specific rules enforced by the operations center module and providing, by the network server module, the content files to a communicatively connected network interface module configured to receive the content files and convert the content files into a format suitable for display on a communicatively connected display device.

### BRIEF DESCRIPTION OF THE DRAWINGS

The present invention will be more readily understood from the detailed description of exemplary embodiments presented below considered in conjunction with the attached drawings, of which:

FIG. 1 illustrates an exemplary alert and media delivery network environment in accordance with an embodiment of the invention;

FIG. 2 illustrates a block diagram of an exemplary alert and media delivery system configured to deliver content to a classroom, in accordance with an embodiment of the present invention;

FIG. 3 illustrates a block diagram of an exemplary operations center module in accordance with an embodiment of the present invention; and

FIG. 4 illustrates a block diagram of an exemplary command and control protocol used to components of a content delivery system according to an embodiment of the present invention.

It is to be understood that the attached drawings are for purposes of illustrating the concepts of the invention and may not be to scale, and are not intended to be limiting in terms of the range of possible shapes and/or proportions. Like reference numerals refer to corresponding parts throughout the several views of the drawings.

### DETAILED DESCRIPTION OF THE INVENTION

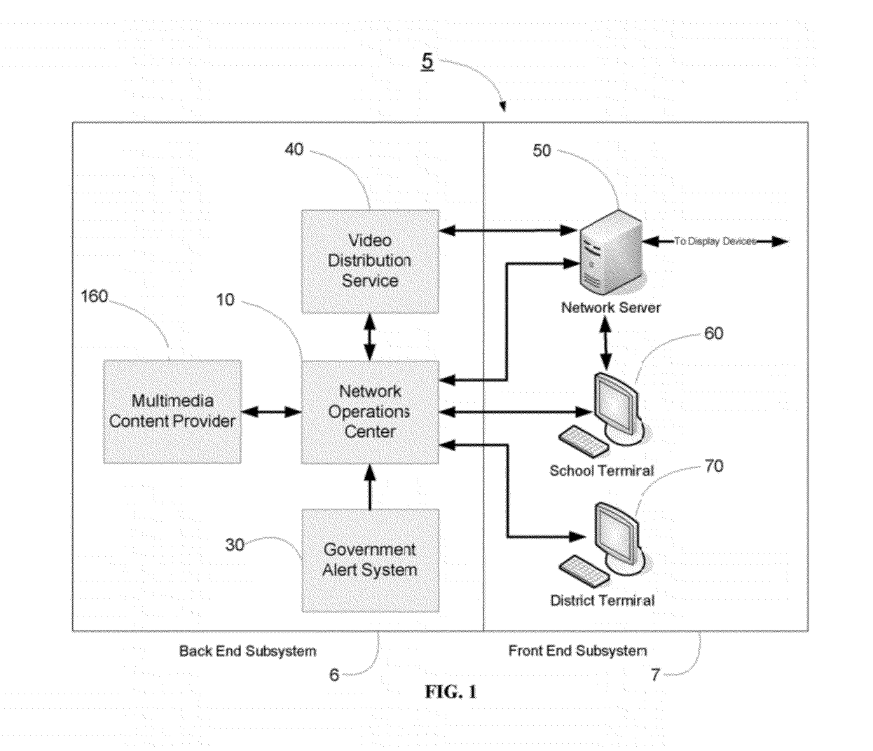

FIG. 1 illustrates a basic network environment comprising a system of the present invention, herein referred to as the content delivery system 5. The term “content” refers to alerts and multimedia content. Multimedia content includes, without limitation, digital audio and video files containing information such as news programs, advertisements and interactive programming. Multimedia content can take a variety of forms such as MPEG audio and video files and other compressed or uncompressed file formats, which will be known to one of ordinary skill in the art. The content delivery system 5 comprises various distinct components which will each be described in greater detail below. In general, the content delivery system 5 comprises a back-end subsystem 6 where alerts and multimedia content are created, received and stored for distribution to a front end subsystem 7 which resides locally at the site for purposes of receiving and displaying alerts and multimedia content from the back-end system 6.

As used herein, the term “alert” refers to any emergency or informational message or communication files which can be received and distributed by the content delivery system 5. According to an embodiment of the present invention, the alerts may comprise weather-related information (such as that available from the National Oceanographic and Atmospheric Administration (NOAA)), national security alerts originating from state or federal government agencies such as the Department of Homeland Security and Federal Emergency Management Administration (FEMA), and other information alerts originating from local or national news or site-specific sources. In addition, alerts may comprise information from local government and law enforcement sources.

The term “site” refers to a school or other organization at which the front end subsystem 7 of the content delivery system 5 is deployed. The site, according to a preferred embodiment of the present invention, is a school district comprised of various school buildings which may include elementary, middle and high schools, daycare centers, and colleges and universities. By way of overview and introduction for purposes of the description below, an embodiment of the present invention is described in detail herein wherein the site is a school. One having ordinary skill in the art will appreciate that the systems and methods of the present invention may be implemented and applied to other environments, such as corporate or governmental implementations, and the detailed description is illustrative of merely one application of the technology. The site may also include a single building such as an individual school or office building. According to the preferred embodiment, the front end subsystem 7 of the content delivery system 5 described herein can be deployed in individual classrooms and administrative offices of each school/school district and is capable of delivering content to students, teachers and site officials, collectively referred to herein as “users.” Other system users include system administrators responsible for maintaining the back end subsystem 6.

Referring to FIG. 1, the content delivery system 5 comprises a network operations center module or “NOC” 10. The NOC 10 comprises one or more computers configured to (1) receive, store and analyze alerts, (2) receive, store and manage the creation of multimedia content either alone or in combination with a multimedia content provider 160 and (3) deliver alerts and multimedia content to the sites. The NOC 10 is the central operations center within the content delivery system 5. The NOC 10 is also configured to receive and store various data concerning content delivery system 5 usage.

As used herein, the term “communicatively connected” is intended to include any type of connection, whether wired or wireless, in which data may be communicated and also includes a connection between devices and/or programs within a single computer or between devices and/or programs on separate computers. As used herein, the term “computer” is intended to include any data processing device, such as a desktop computer, a laptop computer, a mainframe computer, a personal digital assistant, a server, or any other device able to process, manage or transmit data, whether implemented with electrical, magnetic, optical, biological components or otherwise. The term “module” is intended to include, but is not limited to, one or more computers configured to execute one or more software programs configured to perform one or more functions, operations, and/or actions.

The content delivery system 5 comprises a government alert system 30 which collects and aggregates alerts from various government sources including, but not limited to, those mentioned above. The government alert system 30 delivers raw alerts to the NOC 10 and the NOC 10 is configured to determine what alerts to send to a specific site based on rules which reside within the NOC 10 (herein referred to as the “site-specific rules”). Site-specific rules refer to the criteria used by the NOC to determine which content to deliver to a specific site and include, without limitation, various site attributes such as geographic location and type of school. The back end subsystem 6 of the content delivery system 5 also comprises a video distribution service 40 which is responsible for storing multimedia content and delivering the multimedia content to sites via file transfer over a network such as the Internet.

According to an embodiment of the present invention, the front end subsystem 7 comprises a network server 50. Optionally, the front end subsystem 7 comprises a school terminal 60 and/or a district terminal 70. As used herein, the term “terminal” means a dedicated client computer configured to receive and display alerts and/or send alerts to other system components for display one or more classrooms. The network server 50 is configured to receive content from the NOC 10 via a communications network such as the Internet. The network server 50 is also configured to deliver content directly to individual rooms within a site such as offices, classrooms or auditoriums. The content delivery system 5 optionally comprises a school terminal 60 that is communicatively connected to the NOC 10 and the network server 50. When an alert is received by the network server 50 (an inbound alert) from the NOC 10, the school terminal 60 allows a school administrator such as a principal or vice-principal to review the inbound alert and then select from a pre-defined or pre-set list of alert messages for distribution to individual classrooms. The list of pre-set alert messages is maintained by the network server 50 and is sent by the network server 50 to the network interface 110 upon receipt of an instruction/selection by the school terminal 60. In this way, a school administrator has control over the timing, content and destination classroom for alert delivery. Optionally, the content delivery system 5 comprises a district terminal 70 that is communicatively connected to the NOC 10. The district terminal 70 is capable of receiving alerts directly from the NOC 10 and can also receive confirmation and other information regarding alerts sent to classrooms by the school terminal 60 and the network server 50.

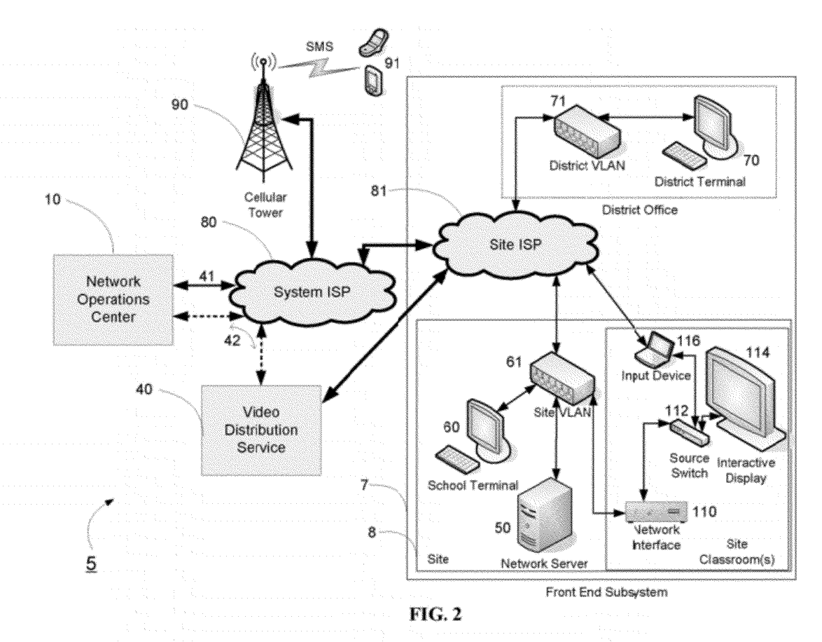

According to an embodiment of the present invention and referring to FIG. 2, the NOC 10 is communicatively connected to the Internet via a dedicated system Internet service provider (ISP) 80. Content originating at the NOC 10 is delivered to a site via the Internet. Such content may be transmitted to the system ISP 80 for distribution across the Internet to the site via the site ISP 81 for further distribution to the site-specific components. According to an embodiment of the present invention, the site ISP 81 comprises a dedicated Internet connection which may include one or more internet protocol (IP) addresses. The decision of whether to implement the content delivery system 5 using a dedicated Internet connection depends on the desired level of security within the system. One having ordinary skill in the art will appreciate that either a dedicated or shared Internet connection may be used as the site ISP 81. According to an embodiment of the present invention, content may be delivered directly by the NOC 10 to the site 8 along path 41. In an alternate embodiment, multimedia content may first be delivered to a video distribution service 40 via the system ISP 80 for delivery to the site via the site ISP 81. The flow of multimedia content from the NOC 10 to the video distribution service 40 is represented by path 42 in FIG. 2.

Once content has been transferred to the site via the site ISP 81, the content is delivered to the site's network server 50 by way of the site virtual local area network (VLAN) 61. Optionally, content may be delivered by the NOC 10 directly to the district terminal 70 by way of the district VLAN 71. The network server 50 is responsible for coordinating content distribution at the site. Content for display in the classroom is first sent by the network server 50 to a communicatively connected network interface or “NI” 110. The NI 110 is a computer configured to convert content into a suitable audio/video format for viewing on an interactive display device 114. A source switch 112, communicatively connected to the NI 110 and interactive display device 114, is a switch configured to control the input being displayed on the interactive display 114. According to an embodiment of the present invention, the source switch 112 is configured to allow a user, such as a teacher, to toggle inputs for the interactive display 114 between the NI 110 and a communicatively connected input device 116, such as a laptop computer. The NI 110 can also be configured to automatically turn the interactive display 114 off and on. In addition, the NI 110 can automatically toggle the source switch 112 away from an input device 116 and to the input being delivered by the NI 110 in the event that an inbound alert is received by the NI 110. One advantage of the present system over the prior art is that delivery of inbound alerts to the interactive display 114 takes priority over other content that is being displayed on the interactive display 114 at the time the inbound alert is received by the network server 50. In this way, inbound alerts can be “pushed” from the network server 50 to the NI 110 and on to the interactive display 114 even if the source switch 112 is initially set to the input device 116. This source switch 112 input override is controlled by the NI 110.

According to an embodiment of the present invention, the NOC 10 is configured to deliver inbound alerts to the school terminal 60 and, optionally, to the district terminal 70. In addition, alerts may be delivered to one or more mobile devices 91 by local cellular towers 90 using short message service (SMS) or other suitable communication protocol. Alerts delivered through SMS originate in the NOC 10 and are then communicated to cellular towers 90 via the system ISP 80. In an alternate embodiment, alerts may also be delivered to the district terminal 70. As noted previously, the district terminal 70 is typically configured to receive inbound alerts from the NOC 10 or confirmation that an alert was initiated by a user from the school terminal 60. However, the district terminal 70 may be configured to perform the same as the school terminal 60, such as allowing district officials to select and deliver inbound alerts to individual site's network server 50.

### Content Delivery System Back End Subsystem 6

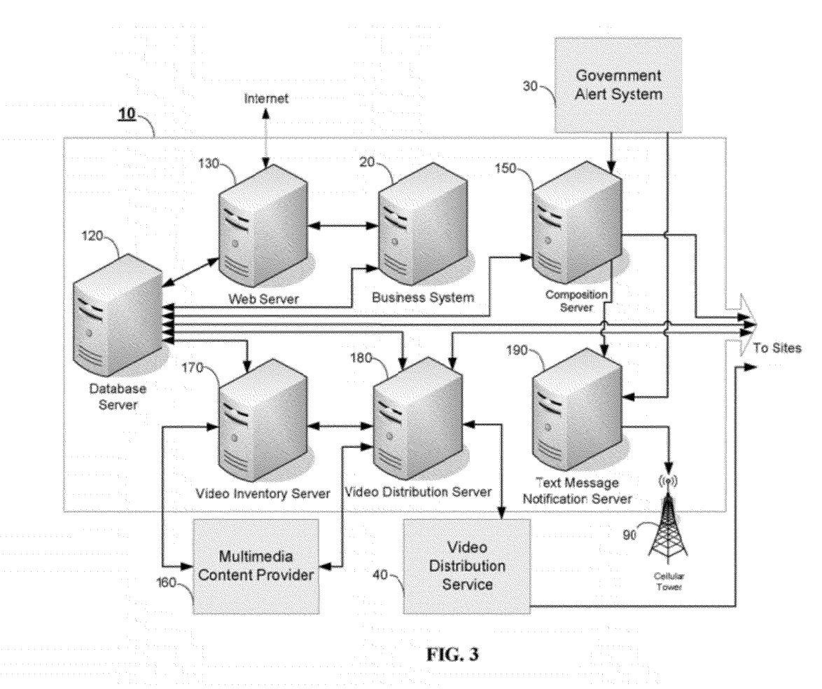

According to an embodiment of the present invention, NOC 10 forms the core of the content delivery system back end subsystem 6. FIG. 3 shows a detailed flowchart of the various components of the NOC 10 according to an embodiment of the present invention. While many of the NOC 10 subcomponents are referred to as “servers,” one having ordinary skill in the art will appreciate that each server may be represented by a server daemon rather than physical server hardware. In addition, a logical server may be composed of one or more separate servers.

A full description of the alert system described herein can be found in U.S. patent application Ser. No. 12/912,677 filed Oct. 26, 2010, titled ALERT NETWORK SYSTEMS AND METHODS, the entire disclosure of which is incorporated herein by reference. The following is a brief description of the functionality of the composition server 150 and text message notification server 190 according to an embodiment of the present invention. The composition server 150 is configured to receive raw alerts from the government alert system 30 and create inbound alerts for delivery to the network servers 50 residing at the sites 8.

According to an embodiment of the present invention, the composition server 150 strips raw incoming alerts of extraneous formatting characters. Message headers are then used to determine the start and end point of each incoming raw alert. In addition, the composition server 150 is configured to examine each incoming raw alert for keywords indicating time/date information, latitude/longitude information, weather emergency codes and other special instructions. The configuration server may be configured to break each incoming raw alert apart for storage in appropriate database fields in the database server 120. The geographic information contained within each incoming alert is then cross referenced with specific site locations that may be affected by the alert condition. Corresponding fields in the database server 120 are then updated for each site affected by the alert condition. The database server 120 may be configured to create an alert based on the type and geographic location of the incoming alert and transmit an inbound alert to the site network server 50.

The composition server 150 is typically configured to send inbound alerts to particular sites 8 based on the site-specific rules that are stored on the database server 120. By way of example and not limitation, the site-specific rules may be developed to send inbound alerts to a particular site 8 based on the geographic location of the site. The composition server 150 may also be configured to analyze incoming raw alerts to determine the severity of such alerts and which site(s) are most likely to be impacted by the particular event detailed in the alert. By way of example and not limitation, an incoming raw alert may detail a tornado approaching a particular town. By knowing the event (i.e., a tornado) and event location (i.e., latitude and longitude), the site-specific rules can be applied to generate an inbound alert for sites located in or near the particular event location.

In addition, the composition server 150 may be configured to deliver inbound alerts directly to the school terminal 60 and district terminal 70 at the same time an alert is delivered to the network server 50. The composition server 150 may be configured to format inbound alerts specifically for display on the school terminal 60 and district terminal 70 using formatting rules for each device. By way of example and not limitation, such formatting rules may include parameters for screen resolution and color depth, audio bit rate, software version number and the “look and feel” of the user interface. Such formatting rules may be stored on the database server 120.

According to an embodiment of the present invention, the text message notification server 190 is communicatively connected to the composition server 150 and can receive raw alerts directly from the government alert system 30 or the composition server 150. The text message notification server 190 may be configured to send and automatically format short message service (SMS) notifications via e-mail to a cell phone provider's e-mail gateway for delivery via cellular towers 90. The list of one or more mobile devices 91 to receive SMS notifications can be customized for each site 8 implementation and may be based on site-specific rules. By way of example and not limitation, the content delivery system 5 can be configured to send SMS alerts to various school officials. One advantage of the present content delivery system 5 over the prior art is the simultaneous use of SMS notifications together with inbound alerts at school terminals 60 and district terminals 70. In this way, the text message notification server 190 adds a level of redundancy to the content delivery system 5 that may be particularly useful for delivering inbound alerts to site officials in instances where, for example, the site 8 has lost electrical power. In alternate embodiments, the text message notification server 190 may be configured to receive alerts directly from the government alert system 30. According to this alternate embodiment, the text message notification server 190 is configured to analyze incoming raw alerts, and send text messages to site officials based on the site-specific rules maintained in the database server 120.

According to an embodiment of the present invention, the database server stores 120 various information related to the content delivery system 5, the content, and the sites 8. The database server 120 may run Microsoft® SQL or any other suitable database management program. Information stored on the database server 120 can include, without limitation, site-specific rules, site information such as site building addresses, including city, county, state and zip code; site multimedia content subscription information, latitude and longitude coordinates for individual buildings within a site, student and teacher information such as name or identification number, site designated market area (DMA) numbers, system usage data including file downloads and student performance data, log-in and system administration credentials, and information regarding alerts received from the government alert system 30 including alert nature, location, speed, duration, etc. One having ordinary skill in the art will appreciate that the type of information that can be logged and stored by the database server 120 will vary based on the particular implementation.

The database server 120 also contains the various site-specific rules that are necessary to direct content delivery system 5 activities. According to one embodiment of the present invention, site-specific rules may be configured to ensure site-specific delivery of alerts. In one example, a particular site-specific rule may be created to notify sites 8 of approaching inclement weather based on site address. In another example, certain multimedia content may be “pushed” to a network server 50 based on a pre-defined playlist for a particular site 8.

According to an embodiment of the present invention, site-specific rules may be created by both site administrators and system administrators. Site administrators may create site-specific rules by way of an application hosted by the web server 130. Such site-specific rules may include, without limitation, the types of alerts to be received by the site, whether alerts may be sent to site network interfaces 110 automatically by a site's network server 50 and specific access permissions associated with setting or modifying a site's alert preferences. Site-specific rules may also be created by system administrators. Examples of these site-specific rules include, without limitation, rules governing which sites are permitted to receive multimedia content packages, the expiration date of subscriptions for such multimedia content packages, playback order and playlist information concerning multimedia content packages and other subscription information pertaining to a site. According to an embodiment of the present invention, individual site devices that communicate with the NOC 10 (e.g., network server 50) must present the NOC 10 with a device identification number that is unique to each device. The NOC 10 then cross references each device identification number against a list stored on the database server 120 before communicating with a given device.

According to an embodiment of the present invention, the NOC 10 comprises a web server 130 which allows various users and system administrators to log into the content delivery system 5 via an Internet-based portal to perform functions such as system and account maintenance and other business functions. The web server 130 can run any suitable server architecture such as the DotNet 3.5 platform. In addition to allowing users and system administrators to access specified portions of the content delivery system 5, the web server 130 also provides for access to the content delivery system 5 by emergency first responders, site officials and the general public.

In one example, the web server 130 provides access to the business system 20. Access controls can be implemented to restrict access by certain individuals to certain parts of the content delivery system 5. Typically, only system administrators of the content delivery system 5 have access to the business system 20. The business system 20 comprises a web-based interface for generating reports and performing certain business functions including, but not limited to: (1) receiving and analyzing Nielsen Rating-specific data received from the NI 110 and the site 8 regarding site's usage of the content delivery system 5; (2) receiving content delivery system 5 hardware usage data including without limitation, status and condition of the school terminal 60 and district terminal 70, status of the interactive display device 114 including projector and lamp life status, custom usage and performance levels collected at the site level, classroom level and student level; (3) play list generation for multimedia content displayed on the school terminal 60, district terminal 70 and interactive display devices 114; (4) generation of reports pertaining to technical support histories indexed by “customer unit” (e.g., school district) required for subscription billing purposes; and (5) generation of reports detailing alert delivery, indexed by customer unit.

According to another embodiment of the present invention, the web server 130 provides a secure web interface for emergency first responders including, but not limited to fire, police, paramedics and HAZMAT personnel. The emergency first responder's web interface permits access to the database server 120 thereby allowing an emergency first responder to gain real-time access to alerts stored in the database server 120. The system may be configured to allow an emergency first responder to view activity reports of alert messages that were previously received by the content delivery system 5. In addition, local communities can use the emergency first responder's web interface to create and manage various emergency procedures to be followed for certain alerts. These procedures may be stored and managed by the network server 50 residing at the site 8 and can be configured to activate upon the occurrence of an event as specified in the emergency procedure. One advantage of the present content delivery system 5 over the prior art is the ability of the content delivery system 5 to allow emergency first responders to access site and alert-specific information when responding to an emergency. This feature provides a powerful public safety tool since an emergency first responder may view only those alerts relevant to the specific site based on a set of site-specific rules maintained in the database server 120 and gather vital information concerning the type of emergency reported in the alert in a timely and targeted manner.

According to another embodiment of the present invention, a site officials' web interface allows designated site officials to access (based on privileges and rules maintained by the NOC 10) the database server 120 for purposes of viewing reports of previously-received alert messages and producing activity reports concerning playback of those messages. In addition, site officials may update contact information for authorized site officials and set access privileges using pre-defined templates. The site officials' web interface also allows site officials to create and manage classroom alerts and distribute such alerts to a specific network interface 110 for delivery to individual classrooms. Site officials may also create and manage customized graphics for use with alerts. By way of example and not limitation, site location attributes such as fire exits, evacuation routes and special action plans may be incorporated into custom alert graphics generated by the network server 50 and delivered for display on the interactive display 114. This functionality provides an advantage over prior art systems in that custom alerts may be displayed depending on the nature and type of inbound alert. For example, a custom alert can be developed that displays a map of the current building and associated fire exits in the event that a local building fire occurs.

According to another embodiment of the present invention, the web server 130 may allow access by the general public to a website hosted on the web server 130 or on a separate server that is physically distinct from other content delivery system 5 components.

According to an embodiment of the present invention, the NOC 10 comprises a video distribution server 180. External multimedia content such as news segments, advertising and other programming may be uploaded to the video distribution server 180 from a multimedia content provider 160 that may be external to the NOC 10. The video distribution server 180 then uploads the digital multimedia tiles to the servers of a video distribution service 40 which may be operated by a third party. The video distribution service 40 is responsible for transferring multimedia content directly to each site's network server 50. In addition, the video distribution server 180 may be configured to send playlists comprising metadata xml files that have been targeted to individual sites 8. These playlists direct the site network server 50 to play back the multimedia content according to a set of pre-defined rules. By way of example and not limitation, a playlist can be configured to select advertisements based on a site's DMA. In this way, the content delivery system 5 is able to target specific sites to receive local advertising content. In other embodiments, the play lists can be targeted to ad hoc “groups” that comprise logical groupings of school buildings that are designated to receive unique content packages. Groups may be created based on any site information contained in the database server 120. For example, various groups can be created using parameters such as school type (i.e. elementary, middle or high), state, zip code and DMA.

According to an embodiment of the present invention, the NOC 10 comprises a video inventory server 170. The video inventory server 170 uploads multimedia content on a periodic basis to network servers 50 located at the sites 8. In one example, multimedia content is transmitted by the multimedia content provider 160 directly to the NOC 10 via the Internet for later transmission to the site's network server 50. Multimedia content residing on the video inventory server 170 typically comprises large MPEG4 files. The multimedia content within these large files is not time-sensitive information and thus may be downloaded to the site network servers 50 during off-peak hours such as nights and weekends. The multimedia content may then be stored on the site's network server 50 and played back at a later time. Time-sensitive content comprises emergency alerts and other multimedia content which can be delivered to the NI 110 directly by the composition server 150 and/or text message notification server 190.

Embodiments of the present invention can be configured to accomplish large file transfers by way of peer-to-peer or “torrent” networks such that each site network server 50 acts as a client that can assist the NOC 10 with large file transfers to other network servers 50. One having ordinary skill in the art will appreciate such that peer-to-peer networks may help reduce server loads at the NOC 10.

According to an embodiment of the present invention, NOC 10 makes extensive use of live connections from field-deployed devices such as network servers 50 and NIs 110. Those devices are constantly attempting to query the database server 120, reporting their health and connectivity, receiving multimedia playback commands and doing database searches. To prevent overload of the database server 120, the NOC 10 does not permit devices to directly connect with and query the database server 120. Queries are sent to a forward facing queue served up using http protocols. The forward facing queue dramatically improves database server 120 throughput and leverages the inherent load balancing strength of HTTP protocols, resulting in a NOC 10 that is able to handle many more simultaneous connections than would otherwise be possible. The forward facing queue also increases database server 120 security by isolating the database server 120 from direct connections. Finally, the forward facing queue provides a simplified means for creating a server array capable of adding additional HTTP servers as demand warrants.

### Front End Subsystem 7

The major components of the front end subsystem 7 of the content delivery system 5 according to an embodiment of the present invention are illustrated in FIG. 2. The content delivery system 5 can be deployed at any site that has Internet connectivity. According to an embodiment of the present invention, enhanced security of the content delivery system 5 is achieved by isolating the content delivery system 5 from the site's network traffic through the use of a site WAN 61. One having ordinary skill in the art will appreciate the various ways in which the site VLAN 61 can be configured to achieve the desired level of security. For example, firewalls may be utilized to deny inbound Internet traffic that does not originate from the NOC 10 or video distribution service 40. Additionally, one of ordinary skill in the art will be able to configure an appropriate network and Internet connection to handle the size and types of files that are transmitted by the content delivery system 5.

According to an embodiment of the present invention, the optional school terminal 60 and optional district terminal 70 are LINUX-based computers. In a school deployment, the school terminal 60 and district terminal 70 may be dedicated clients that are incapable of running software other than the particular content delivery system 5 interface. One having ordinary skill in the art will recognize that any suitable computer may be used for the school terminal 60 or district terminal 70. The primary purpose of the school terminal 60 and district terminal 70 are to receive inbound alerts from the NOC 10. In a school deployment, the school terminal 60 is typically located in a school official's office. The school official may be a principal, vice-principal or other designated individual. Once an inbound alert is received on the school terminal 60, the school official can review the alert on the school terminal 60 display. Depending on the type of alert, the school official may then command the school terminal 60 to send instructions to the network server 50 to have one of a pre-defined alerts delivered to one or more classrooms in the school for display on the interactive display 114. The alerts may be emergency alerts or non-emergency alerts. For example, the alert may comprise morning announcements for a particular school. The graphical representation of the alert (i.e. text, graphics, colors) may be selected from a pre-determined set of templates that are programmed into software running on the school terminal 60.

The district terminal 70 is similar to the school terminal 60. According to an embodiment of the present invention, the district terminal 70 is configured to receive inbound alerts simultaneously with the school terminal 60. The district terminal 70 is typically located in a district office that is separate from the particular site where a school terminal 60 is located. In an exemplary embodiment, the district terminal 70 is isolated from other network traffic of the district office via use of a district VLAN 71 that is similar to the site VLAN 61. In addition to receiving inbound alerts, the district terminal 70 can receive information logged by the network server 50, via the NOC 10, concerning use of the school terminal 60. For example, the district terminal 70 can be configured to receive information about alerts sent from the school terminal 60 such as the identity of the person sending the alert, the school terminal 60 from which the alert was sent, the type of alert sent and when the classroom alert was sent. In this way, the district terminal 70 allows district officials to monitor how the content delivery system 5 is being used by local school officials. In some embodiments, the district and site offices do not communicate directly with one another but instead through the NOC 10.

### Network Server 50

According to an embodiment of the present invention, the network server 50 delivers inbound alert messages and multimedia content directly to the site 8 classrooms. In one example, the network server 50 is comprised of four logical server daemons, all of which are database and interne enabled. The media server daemon receives, stores, delivers and deletes content for the school classroom interactive display devices 114. Multimedia content is received from the NOC 10 and from the video distribution service 40 which may be operated by a third party. Multimedia content may be pushed to the classroom NI 110 or pulled on demand by an individual classroom using the input device 116. According to an embodiment of the present invention, the media server contains a search engine function to allow users such as teachers to search and find curriculum-related content that is stored on the network server 50. User interaction with the network server 50 from individual classrooms is coordinated through the NI 110. Once the desired multimedia file is located, the content can be streamed from the network server 50 to the interactive display 114 in the classroom via the NI 110. The media server daemon is also responsible for receiving and managing the playlists.

The network server 50 may also comprise a command and control daemon. The command and control daemon executes commands that communicate with the network interface 110 and controls certain functionality of the interactive display 114 such as “on” and “off” commands. The command and control daemon may be configured to control classroom projectors through a suitable protocol, including without limitation, RS-232 or simple network management protocol (SNMP). The command and control daemon may also be configured to receive commands from the school terminal 60 that contain instructions for displaying the inbound alert messages on the interactive display 114. According to an embodiment of the present invention, the command and control daemon is aware of, and can directly address, every front end 7 device attached to the content delivery system 5.

The network server 50 may also comprise a network interface management daemon that is capable of managing the booting and updating of each NI 110 connected to the content delivery system 5. In addition, the log file and usage return daemon may be configured to receive and forward log files on usage from the NI 110 and interactive display 114. These log files allow for the analysis of viewing habits and ratings for multimedia content delivered by the system. The log files can also allow business partners such as device vendors to review usage data and other relevant information. Such usage information may include, without limitation, trouble codes generated by the interactive display 114, how long the interactive display 114 has been in service, lamp and projector usage information, lamp life remaining and other information depending on the particular system implementation. The log files are stored in a local database on the network server 50 for later retrieval and transfer to the NOC 10.

According to an embodiment of the present invention, the network server 50 can be configured to accept audio and video inputs, both analog and digital, and stream local playbacks to the network interfaces 110 and interactive display devices 114 in individual classrooms. This functionality allows a site to distribute its own site-specific content in real time to one or more classrooms.

### Network Interface (NI) 110

According to an embodiment of the present invention, each classroom within a school site can house a NI 110. According to an embodiment of the present invention, the NI 110 is communicatively connected to the network server 50, the source switch 112 and the interactive display 114. The NI 110 receives content from the network server 50 and converts that content into a format suitable for display on the interactive display 114. One having ordinary skill in the art will recognize that a variety of suitable display formats are available such as, for example, VGA, DVI and HDMI. The NI 110 can also be configured to convert content into a suitable audio format for broadcasting sound through loudspeakers installed in each classroom. The NI 110 is also capable of communicating with the interactive display 114 and the source switch 112 and can receive keyboard/mouse commands from the input device 116 or the interactive display 114 (via the source switch 112) and usage information from the interactive display 114 while issuing command and control signals to both the source switch 112 and interactive display 114.

According to an embodiment of the present invention, the NI 110 boots directly from the network server 50 utilizing a boot image that is transferred from the network server 50 to the NI 110. In this way, no operating system is physically loaded on the NI's 110 system memory. Upgrades to the NI's 110 boot image including installed applications can be achieved by loading such upgrades onto the network server 50 via the NOC 10. Advantageously, all network interfaces 110 that are attached to the content delivery system 5 can be upgraded directly from the NOC 10. This process allows the content delivery system 5 administrators to quickly deploy upgrades and patches as necessary without having to rely on human intervention on the site side, with the possible exception of a manual network interface 110 reboot.

According to an embodiment of the present invention, the NI 110 is configured to perform the following functions: log file generation, log playback reports, hourly status report generation, Nielsen data generation, usage data report generation, playlist handling and administration and remote monitoring and administration. The NI 110 may also be configured to display a custom user interface and menu system on the input device 116. In addition, either the NI 110 or network server 50 can collect status information regarding content delivery system 5 usage which may include, without limitation, the nature of an alert and when playback occurred (date and time) and the individual classroom(s) receiving the alert based on unique identifiers assigned to each classroom and NI 110.

### Source Switch

Embodiments of the present invention utilize a source switch 112 that is connected to the NI 110, interactive display device 114 and various input devices 116. The source switch 112 is responsible for changing the display sources as commanded by the NI 110 and overriding all possible user-selected input devices 116. The source switch 112 can also be configured to relay usage information from the interactive display 114 back to the NI 110. According to an embodiment of the present invention, the source switch 112 receives commands directly from the NI 110, preferably through a USB interface, and does not have a separate operating system. One of ordinary skill in the art will appreciate that the source switch 112 may contain suitable audio/video inputs/outputs and connectivity ports such as USB inputs and Ethernet ports.

### Interactive Display

Embodiments of the present invention utilize an interactive display 114 for viewing content received at the NI 110. The preferred embodiment of the present invention comprises an interactive white board as the interactive display 114. Several commercially-available interactive white boards may be integrated with embodiments of the present content delivery system 5. Preferred interactive white boards comprise a display surface measuring at least 55 inches in the diagonal direction. Content may be displayed on the interactive white board by way of a projector mounted above the device. One having ordinary skill in the art will appreciate that various suitable interactive display devices 114 can be used with the present invention.

Some commercially-available interactive display devices 114 also allow for user interaction directly with the device. These user interactions with the interactive display can be logged and relayed back to the NI 110, network server 50 and input device 116 for later analysis. Such user data may also be sent to the NOC 10 by the network server 50 for storage and later analysis. Other interactive displays 114 utilize touch screen technology for logging user interaction with the device. Still other interactive displays utilize remote control-like devices (i.e., “clickers”) which can communicate wirelessly with a receiver (either in the interactive display 114 or external) and log user actions. For example, each student in a school classroom may be given a clicker for recording each student's individual answer to a given question that is displayed on the interactive display. Each student's responses can then be recorded and analyzed by the system to track student progress and learning achievement.

### Command and Control Configuration

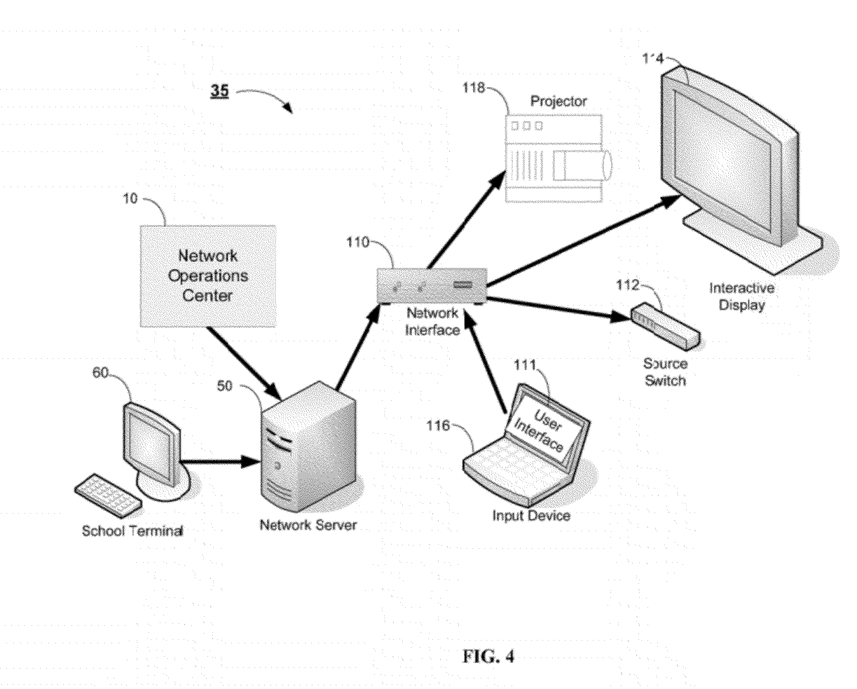

FIG. 4 illustrates a command and control scheme 35 according to an embodiment of the present invention. Arrows in FIG. 4 do not indicate physical connections but instead indicate a control hierarchy. The device at the beginning of an arrow controls the device at the end of the same arrow. The NOC 10 controls the network server 50. Network server 50 functionality controlled by the NOC 10 includes, without limitation, content management and log file uploads and downloads. According to the preferred embodiment, the NOC 10 is communicatively connected to the network server 50 by means of an Internet connection. However, one having ordinary skill in the art will recognize that other suitable connection means exist, for example, satellite connectivity. According to an embodiment of the present invention, the school terminal 60 controls the network server 50. The network server 50 functionality controlled by the school terminal 60 includes, without limitation, alert management and alert delivery. According to the preferred embodiment, the school terminal 60 is communicatively connected to the network server 50 via Ethernet wiring. According to an embodiment of the present invention, the network server 50 controls the NI 110. NI 110 functionality that may be controlled by the network server 50 includes, without limitation, network boot image management, alert playback and multimedia content playback.

According to an embodiment of the present invention, the NI 110 controls the source switch 112, interactive display 114 and an optional projector 118. The NI 110 may control the switching functionality of the source switch 112 allowing a user to toggle inputs between the NI 110 and input device 116. According to the preferred embodiment, the source switch 112 is communicatively connected to the NI 110 via a USB connection which allows communication transport between the two devices. In an alternate embodiment, the NI 110 and source switch 112 may be connected via Ethernet cabling. According to an embodiment of the present invention, the NI 110 controls the on/off functionality of the interactive display 114 and projector 118. On/off functionality can be controlled using any suitable communication protocol including, without limitation, RS232 signaling. In such a control scheme, the projector 118 may transmit its model number and current state (i.e. on or off) to the NI 110. In the case of interactive displays 114 such as interactive white boards, various functions may be controlled via USB communication using manufacturer-specific commands. The projector 118 and interactive display 114 are preferably controlled via the source switch 112.

According to an embodiment of the present invention, the NI 110 is controlled by a user via a user interface 111. The user interface 111 may take any one of several suitable forms. In one example, the user interface 111 resides directly on the NI 110 and allows control of such features as input device selection and multimedia playback functions such as stop, play and volume control. One having ordinary skill in the art will recognize that a variety of on-board user interfaces 111 can be devised that remain within the scope of the present invention. According to the preferred embodiment, the user interface 111 can be in the form of software installed on the input device 116. To control the NI 110, a user would launch a special software application installed on the input device 116 that is configured to allow the user to search and view content residing on the network server 50 and control the input and output of the NI 110. Additional functionality related to multimedia playback (i.e. volume control, stop, play, etc.) may also be programmed into the software application. When using an external user interface 111 via the input device 116, the input device 116 is communicatively connected to the user NI 110. According to an embodiment of the present invention, instructions sent by the network server 50 to the NI 110 override any instructions sent to the NI 110 by the user interface 111. Such an override may occur, for example, when an inbound alert is received by the network server 50 for distribution to site classrooms. The state of the input device 116 remains unchanged and once the alert concludes, normal operation of the NI 110 is resumed.

The above-described functions and components can be comprised of instructions that are stored on a storage medium such as a computer-readable medium. The instructions can be retrieved and executed by a processor. Some examples of instructions are software, program code and firmware. Some examples of storage medium are memory devices, tape, disks, integrated circuits and severs. The instructions are operational when executed by the processor to direct the processor to operate in accordance with embodiments of the present invention. Those having ordinary skill in the art are familiar with suitable instructions, processor(s) and storage media.

The present invention is described above with reference to exemplary embodiments. It will be apparent to those skilled in the art that various modification may be made and other embodiments can be used without departing from the broader scope of the present invention. Therefore, these and other variations upon the exemplary embodiments are intended to be covered by the present invention.

What is claimed is:

1. A method for providing content to a site, the method comprising the steps of:
managing, by a network operations center module, a plurality of content files comprising at least one alert file and at least one multimedia file;
delivering a content file from the network operations center module to a communicatively connected network server module associated with the site based on one or more site-specific rules enforced by the network operations center module; and
providing, by the network server module, the content file to a communicatively connected network interface module configured to receive the content file and convert the content file into a format suitable for display on a communicatively connected display device.

2. The method of claim 1, further comprising receiving at least a portion of the plurality of content files from at least one of a plurality of communicatively connected sources.

3. The method of claim 1, wherein the multimedia file is delivered from the network operations center module to the communicatively connected network server module via a video distribution service.

4. The method of claim 1, wherein the network interface module is configured to boot based on a boot image received from the network server module.

5. The method of claim 1, wherein the network interface module is configured to power on the communicatively connected display device in order to display the content.

6. The method of claim 1 further comprising providing, by the network server module to the network interface module, instructions identifying the content for display on the display device.

7. The method of claim 1, wherein the display device resides in a classroom of the site.

8. The method of claim 7, wherein the display device is an interactive display.

9. The method of claim 1, wherein the display device is communicatively connected to a display source switch module configured to connect the display device to the network interface module and one or more other display sources.

10. The method of claim 9, wherein the display source switch module is controlled by the network interface module.

11. The method of claim 10 further comprising switching, by the display source switch module, an input to the display device between the network interface module and the one or more display sources.

12. The method of claim 10 further comprising switching, by the display source switch module, from one of the display sources to the network interface module when a time-sensitive alert is communicated by the network interface module.

13. The method of claim 9 further comprising relaying, by the display source switch module to the network interface module, usage information relating to the display device.

14. The method of claim 1, further comprising receiving by the network server module, from a communicatively connected school terminal module residing locally at the site, an instruction to deliver one of a plurality of preset messages to the network interface module.

15. The method of claim 14, wherein a notification concerning delivery of one of the plurality of present messages is communicated by the network operations center module to a communicatively connected district terminal module residing locally at the site.

16. The method of claim 1 further comprising receiving, by the network server module from the network interface module, status information relating to at least one of the network interface module, the delivered content, and the display device.

17. The method of claim 1, wherein the plurality of sources comprises a government alert system.

18. The method of claim 1, further comprising sending, by the network server module to the network interface module, one or more software updates.

19. The method of claim 1, wherein the multimedia file comprises a playlist customized by the network operations center module for the site based on the one or more site-specific rules.

20. A system for providing content to a site, the system comprising:
a network operations center module configured to manage a plurality of content files comprising at least one alert file and at least one multimedia file;
a network server module associated with the site configured to receive the content file from the network operations center module based on one or more site-specific rules enforced by the network operations center module; and
a network interface module configured to receive the content tile from the network server module and convert the content file into a format suitable for display on a communicatively connected display device.

21. The system of claim 20, wherein the network operations center module is configured to receive at least a portion of the plurality of content files from at least one of a plurality of communicatively connected sources.

22. The system of claim 20, wherein the network interface module is configured to boot based on a boot image received from the network server module.

23. The system of claim 20, wherein the network interface module is configured to power on the communicatively connected display device in order to display the content.

24. The system of claim 20, wherein the network interface module is configured to receive from the network server module, instructions identifying the content for display on the display device.

25. The system of claim 20, wherein the display device resides in a classroom of the site.

26. The system of claim 25, wherein the display device is an interactive display.

27. The system of claim 20, wherein the display device is communicatively connected to a display source switch module configured to connect the display device to the network interface module and one or more other display sources.

28. The system of claim 27, wherein the display source switch module is controlled by the network interface module.

29. The system of claim 28, wherein the display source switch module is configured to switch an input to the display device between the network interface module and the one or more display sources.

30. The system of claim 28, wherein the display source switch module is configured to switch from one of the display sources to the network interface module when a time-sensitive alert is communicated by the network interface module.

31. The system of claim 27, wherein the display source switch module is configured to relay to the network interface module, usage information relating to the display device.

32. The system of claim 20, wherein a communicatively connected school terminal module residing locally at the site is configured to receive, from the network server module, an instruction to deliver one of a plurality of preset messages to the network interface module.

33. The system of claim 32, wherein a communicatively connected district terminal module residing locally at the site is configured to receive a notification concerning delivery of one of the plurality of preset messages communicated by the network operations center module.

34. The system of claim 20 wherein the network server module is configured to receive from the network interface module, status information relating to at least one of the network interface module, the delivered content, and the display device.

35. The system of claim 20, wherein the plurality of sources comprises a government alert system module.

36. The system of claim 20, wherein the network server module is configured to send to the network interface module one or more software updates.

37. The system of claim 20, wherein the multimedia file comprises a playlist customized by the network operations center module for the site based on the one or more site-specific rules.

38. A non-transitory computer readable medium comprising executable instructions, the instructions being executed by a processor to perform a method, the method comprising;
managing, by a network operations center module, a plurality of content files comprising at least one alert file and at least one multimedia file;
delivering a content tile from the network operations center module to a communicatively connected network server module associated with the site based on one or more site-specific rules enforced by the network operations center module; and
providing, by the network server module, the content file to a communicatively connected network interface module configured to receive the content file and convert the content file into a format suitable for display on a communicatively connected display device.
